(19) United States
(12) Patent Application Publication
(10) Pub. No.: US 2024/0252385 A1
(43) Pub. Date: Aug. 1, 2024

(54) RECOVERY AND WELLNESS APPARATUS

(71) Applicant: JTL Enterprises, Inc., Clearwater, FL (US)

(72) Inventors: Paul LUNTER, Palm Harbor, FL (US); Timothy ELLIOT, Pinellas Park, FL (US); Mario SIMOES, Pinellas Park, FL (US)

(21) Appl. No.: 18/102,307

(22) Filed: Jan. 27, 2023

(51) Int. Cl. A61H 9/00

(52) U.S. Cl. CPC A61H 9/0021; A61H 2009/0042; A61H 2201/0138; A61H 2201/0207; A61H 2201/0214; A61H 2201/0221; A61H 2201/1654

(57) ABSTRACT

An apparatus for massage of a user in a reclined position, having a housing structure having a base portion with a user support surface for supporting the user in a reclined position, and a massage assembly disposed adjacent the user support surface, the massage assembly including at least one fluid storage reservoir, at least one fluid bag disposed within the user support surface, and at least one fluid pump in fluid communication with both the at least one fluid storage reservoir and the at least one fluid bag, wherein the at least one fluid pump is configured to circulate fluid from the at least one fluid storage reservoir to the at least one fluid bag.

### CROSS-REFERENCE TO RELATED APPLICATIONS

The present application is a Continuation-in-Part of U.S. patent application Ser. No. 17/511,914 filed Oct. 27, 2021, which claims priority to U.S. Provisional Patent Application No. 63/106,697, filed Oct. 28, 2020, the entire disclosures of which are incorporated by reference herein.

### FIELD OF INVENTION

The present disclosure relates generally to apparatus for applying a relaxing effect to the body of a user and, more particularly, to an apparatus utilizing multiple effects on the senses of a user to obtain a relaxing effect.

### BACKGROUND

Cryotherapy treatments utilizing extremely cold temperature fluids have gained popularity in recent years to help users with pain relief, muscle recovery, prevention of inflammation, etc. However, various issues and potential dangers exist for known methods of applying cryotherapy treatments. For example, direct contact with the extremely cold fluids, or containers they are enclosed within, may lead to hypothermia, skin irritation, and even frost bite in extreme circumstances. As well, existing treatments often require highly trained personnel to administer them which leads to reduced availability and increased expense. Moreover, existing treatments often require direct contact with the liquids, such as submersion in ice baths, which require the person undergoing the treatments to achieve some level of undress which may lead to inconvenience. Lastly, some methods of application include the utilization of ice and heat packs that can be rather inconvenient.

As well, massage is a time-honored and effective therapy for achieving relaxation, as well as treating muscular injuries, strains and general soreness. However, although massage is recommended by many physicians for such purposes, similarly to traditional cryotherapy treatments, massage therapy often has limited availability due to a scarcity of trained, qualified masseurs. As a result, many devices and apparatus have been proposed in the past for producing a massage-like manipulation of a user's body by various means, ranging from mechanically or electrically generated vibrations or pulsations, often accompanied by heating.

The majority of such known massage apparatus are in the form of a bed-type structure having an essentially horizontal user support surface on which the user may lay in a recumbent position. Advantageously, the horizontally recumbent position of the user's body in such bed-type structures enables either a portion or the entire length of the user's body to be treated by the massage apparatus. On the other hand, one of the disadvantages of a bed-type massage apparatus is that the supine disposition of the user is not conducive to enabling the user to engage in other activities during the operation of the apparatus, e.g., reading, watching television, operation of a laptop computer or other personal electronic device, etc. Additionally, experience has shown that many individuals feel uncomfortable using an open bed-type massage apparatus in public in which they are required to lie down on the machine and visible to all other occupants of the room in which the massage apparatus is disposed. Many users suggest that a reclined or seated disposition would lead them to feel less vulnerable, as well as an apparatus that offered more privacy than a standard bed-type apparatus. As well, because the known bed-type massage apparatus have no structure above the flat bed-type structure, the user is subjected to the environment (gym, care facility, etc.) surrounding the massage apparatus, which may lack the proper ambiance to achieve the desired level of relaxation. For such reasons, a desire has been expressed in the industry for a dry hydro-therapy massage apparatus wherein the user rests in a generally seated disposition during operation of the apparatus, allowing the user to read a book or magazine, watch television, or remain otherwise occupied with other activities.

As such, there is a desire to provide systems and methods that accommodate the application of both heat and cold treatments to an individual simultaneously.

### SUMMARY

One embodiment in accordance with the present disclosure is an apparatus for massage of a user in a reclined position, having a housing structure having a base portion with a user support surface for supporting the user in a reclined position, and a massage assembly disposed adjacent the user support surface, the massage assembly including at least one fluid storage reservoir, at least one fluid bag disposed within the user support surface, and at least one fluid pump in fluid communication with both the at least one fluid storage reservoir and the at least one fluid bag, wherein the at least one fluid pump is configured to circulate fluid from the at least one fluid storage reservoir to the at least one fluid bag.

Yet another embodiment of the present disclosure provides an apparatus for massage of a user having a housing structure having a base portion with a user support surface for supporting the user in a reclined position, and a massage assembly disposed adjacent the user support surface, the massage assembly including at least one fluid storage reservoir, at least one fluid bag disposed within the user support surface, a fluid cooling assembly, a fluid heating assembly, and at least one fluid pump in fluid communication with the at least one fluid storage reservoir and the at least one fluid bag, wherein the at least one fluid pump is configured to circulate fluid from the at least one fluid storage reservoir, the fluid cooling assembly, the fluid heating assembly, and the at least one fluid bag.

The accompanying drawings, which are incorporated in and constitute a part of this specification, illustrate one or more embodiments of the disclosure and, together with the description, serve to explain the principles of the invention.

### BRIEF DESCRIPTION OF THE DRAWINGS

A full and enabling disclosure of the present disclosure, including the best mode thereof, directed to one of ordinary skill in the art, is set forth in the specification, which makes reference to the appended drawings, in which:

FIGS. 1A, 1B, and 1C are a right side plan view, a front perspective view, and a rear perspective view of a recovery and wellness pod apparatus in accordance with an embodiment of the present disclosure;

FIG. 2 is a right side perspective view of the recovery and wellness pod apparatus shown in FIGS. 1A, 1B, and 1C, with the user support surface removed to show interior details;

FIGS. 3A, 3B, 3C, and 3D are front, rear, top, and bottom plan views of the recovery and wellness pod apparatus shown in FIGS. 1A, 1B, and 1C;

FIG. 4 is a cross-sectional view of the recovery and wellness pod apparatus shown in FIG. 2, taken along line 4-4; and

FIG. 5 is a block diagram of an example recovery and wellness pod apparatus architecture in accordance with the sample embodiments.

FIGS. 6A, 6B, and 6C are a front perspective view, a right-side plan view, and a top plan view of a recovery and wellness apparatus in accordance with an alternate embodiment of the present disclosure;

FIGS. 7A and 7B are a left-side perspective view and a top plan view of the recovery and wellness apparatus shown in FIGS. 6A, 6B, and 6C, with the user support surface removed to show interior details;

FIG. 8 is a cross-sectional view of the recovery and wellness apparatus shown in FIG. 6C, taken along line 8-8; and

FIG. 9 is a perspective view of the recovery and wellness apparatus shown in FIG. 6C with the access hatch open to the interior of the housing.

Repeat use of reference characters in the present specification and drawings is intended to represent same or analogous features or elements of the invention according to the disclosure.

### DETAILED DESCRIPTION

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

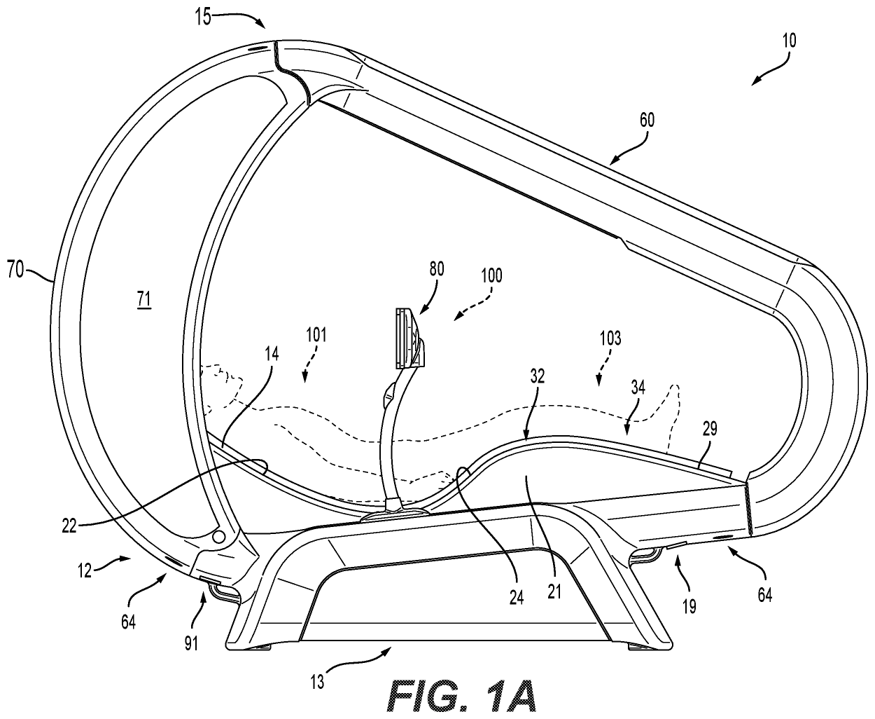

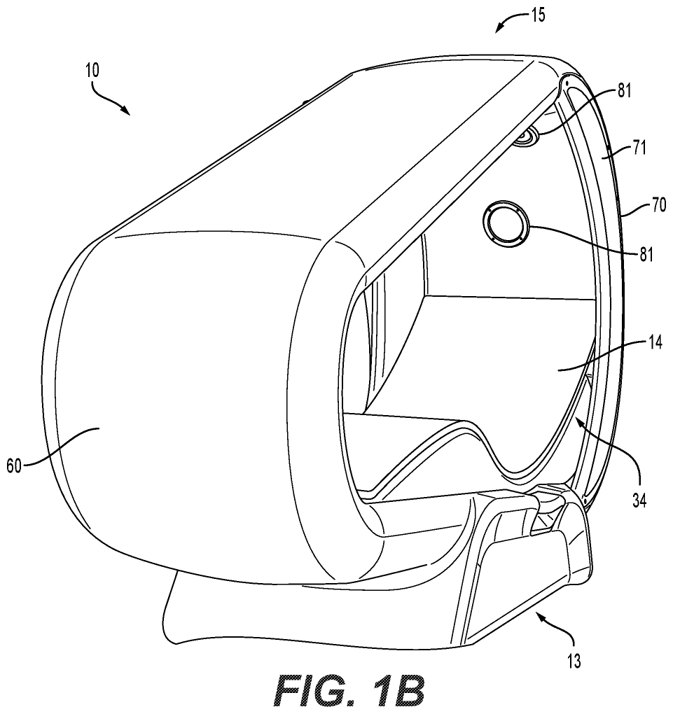

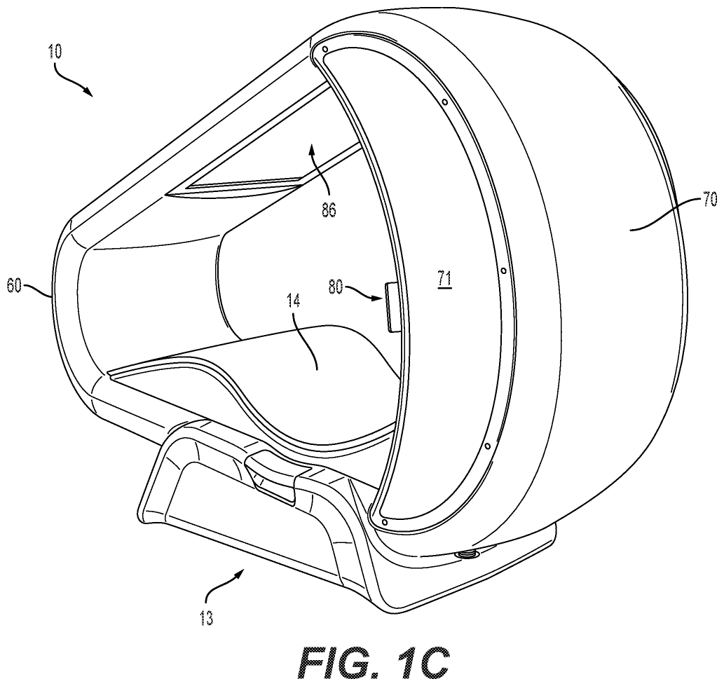

As used herein, terms referring to a direction or a position relative to the orientation of the recovery and wellness assembly, such as but not limited to “vertical,” “horizontal,” “top,” “bottom,” “above,” or “below,” refer to directions and relative positions with respect to the recovery and wellness assembly's orientation in its normal intended operation, as indicated in FIGS. 1A, 1B, and 1C. Thus, for instance, the terms “vertical” and “top” refer to the vertical orientation and relative upper position in the perspective of FIGS. 1A, 1B, and 1C and should be understood in that context, even with respect to a recovery and wellness assembly that may be disposed in a different orientation.

Further, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “and” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “and,” and “the” may include plural references, and the meaning of “in” may include “in” and “on.” The phrase “in one embodiment,” as used herein, does not necessarily refer to the same embodiment, although it may.

As will be readily understood by persons skilled in the relevant art, the recovery and wellness apparatus of the present disclosure is readily adapted to be embodied in many and various forms to accommodate relaxation of a user in differing reclined positions. The present disclosure is described herein in one contemplated embodiment of such apparatus, but only for purposes of providing an exemplary enabling disclosure of the invention and, in particular, the invention is not intended to be limited, and should not be construed as limited, to application or embodiment in such apparatus nor any other particular structure except as defined in the claims appended hereto.

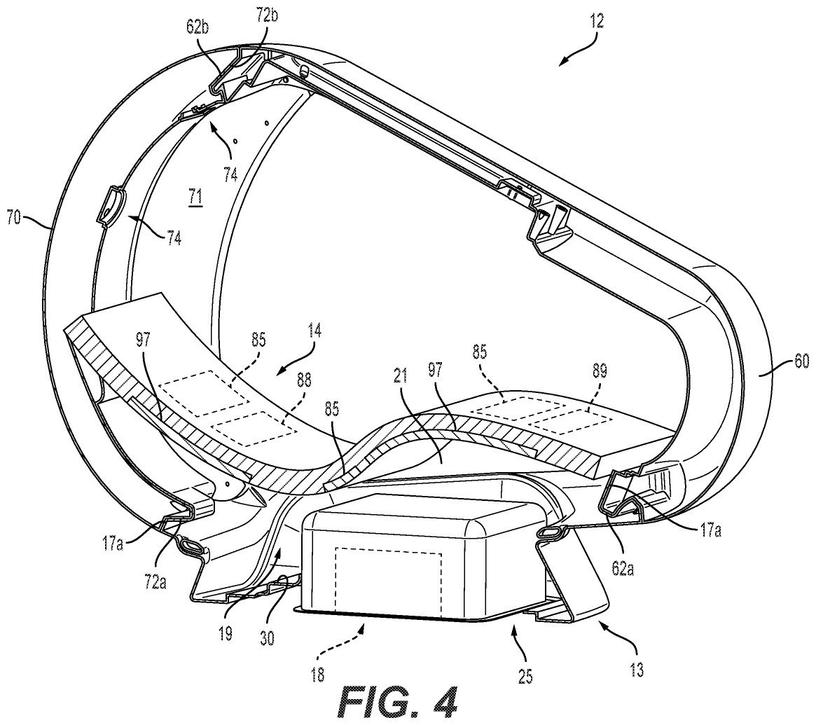

Referring now to the accompanying drawings and initially to FIGS. 1A through 1C, a recovery and wellness apparatus according to one embodiment of the present disclosure is generally indicated at 10. The apparatus 10 includes a housing structure, generally indicated at 12, generally in the form of a hollow lounge chair-style base housing shell 13, including atop cover structure 15 extending the length thereof. The base housing shell 13 presents an upwardly facing top side configured to receive a user support surface 34 thereon that is designed for a user 100 to rest thereon for treatment. These treatments may include, but not limited to, massage, aromatherapy, auditory sessions, etc., in a seated reclining position, as more fully explained hereinafter. A fluid spray assembly, generally indicated at 16 (FIG. 4), is disposed within the base housing shell 13 in association with a pressurized fluid supply arrangement 18, which is disposed within the hollow base housing shell as well and includes a pump 28, preferably a liquid pump, for directing a pressurized fluid emission from a liquid storage reservoir 29 at the underside of the user support surface 34 to transmit a massaging effect therethrough to the body of the user 100 seated thereon.

Referring additionally to FIG. 4, the base housing shell 13 is preferably generally in the form of a tank or tub of an elongated configuration having a bottom wall 30 and side walls 21, and substantially open at its top to define an upwardly-facing elongated opening. Preferably, the bottom wall 30 may also define an aperture therein that is configured to receive an enclosure 25 therein for containing various components of the fluid supply arrangement 18, such as the pump 28, fluid reservoir 29, etc. As shown in FIG. 4, the perimeter of the aperture defined in the bottom wall 30 of the base housing shell 13 forms a leak-proof seal with the outer surface of the enclosure 25. As such, water utilized by the fluid spray assembly 16 during massage treatment of the user 100 is retained within the base housing shell 13 until returned to the water storage reservoir 29 within the enclosure 25 via associated piping. The base housing shell 13 may be fabricated of any suitable watertight, rigid material of appropriate strength which may be formed to the desired configuration herein described, e.g., fiberglass, plastic, or a like material. The base housing shell 13 provides an open volume 19 (FIG. 4) beneath the user support surface 34 for enclosure of various operating components of the apparatus 10.

As best seen in FIGS. 1A and 1B, the lateral side walls 21 of the base housing shell 13 are contoured to form a substantially-planar seat back portion 22 and a seat portion 24 having a substantially-planar leg portion 29, supporting the user support surface 34. Preferably, the seat back portion 22 and the leg portion 29 are angularly oriented with respect to each other, with the seat portion 24 being disposed therebetween. The user support surface 34 is configured so that the upper and lower body portions 101 and 103, respectively, of the user 100 are supported in a generally reclining seated disposition comparable to that of a lounge-style chair wherein the user's body rests bent at the waist and knees with the upper body portion 101 partially reclined on the seat back portion 22, the upper leg extent of the lower body portion 103 slightly inclined on the seat portion 24, and the lower leg extent of the lower body portion 103 slightly declined on the leg portion. The slight bend of the knees of the user's legs help to maintain the user 100 in the proper position on the user support surface 34. As such, the pressurized water jets will impact the user 100 in the proper areas of the user's body to achieve the desired massaging effect.

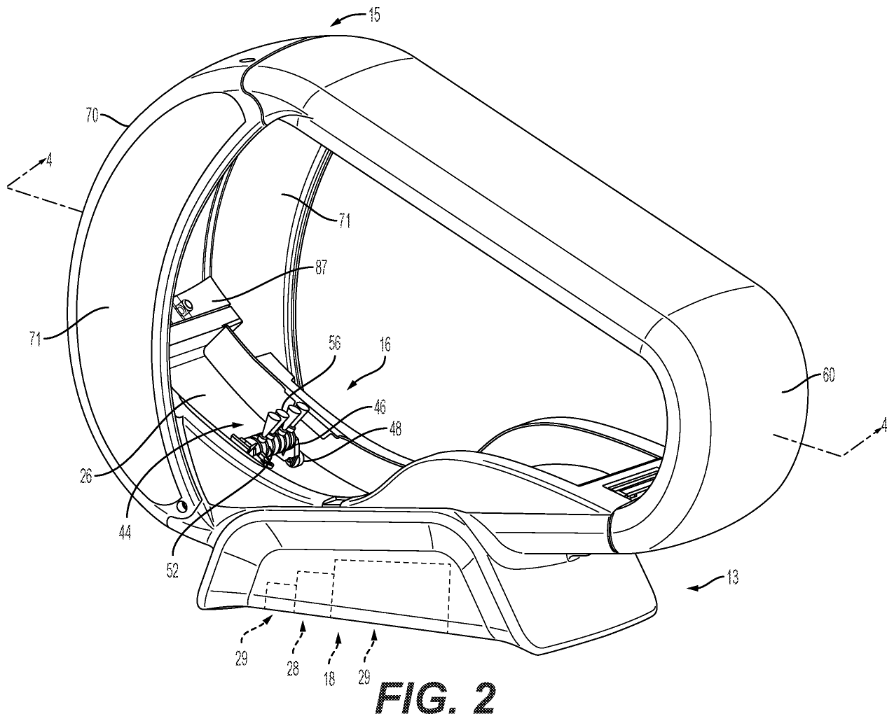

A liquid medium is preferred as the fluid medium utilized by the apparatus 10 for supply to and emission from the fluid spray assembly 16 to produce a massage effect as hereinafter described, water being an optimal liquid in view of its ready availability and generally non-corrosive and non-caustic character. As noted, a suitable supply of water is stored in the water storage reservoir 29 for continuous circulation through the fluid supply arrangement 18 to the fluid spray assembly 16. The bottom drainage wall 30 (FIG. 2), as well as the other interior surfaces of the base housing shell 13 are configured to drain the liquid emitted from the fluid spray assembly 16 into the water storage reservoir 29. Of course, as those persons skilled in the art will readily recognize, pressurized air, other gases, and other fluidic materials could also be utilized as the fluid massaging medium without departing from the scope and substance of the present disclosure and, accordingly, the present disclosure is not intended to be and should not be construed as limited to the use of water or another liquid massage medium.

It is also preferred that the water or other massage liquid be heated to enhance the massaging effect produced by the liquid, e.g., to a temperature approximating normal body temperature, preferably in the range of 95 to 100 degrees Fahrenheit, although the apparatus has the capability of a broad range of liquid temperatures. For this purpose, a heater element (not shown) may be provided, e.g., mounted within the storage reservoir 29 below the normal level of massage liquid therein to be substantially continuously submerged in the stored massage liquid. A thermostat (not shown) is preferably provided in the electrical circuit to the heating element to provide selective control of the temperature of the massage liquid by the user.

In the preferred embodiment of the apparatus 10, in which the fluid spray assembly 16 is utilized for fluid massage, the user support surface 34 may be formed of a relatively thin sheet of a waterproof material affixed in watertight relationship with a flange 32 bordering the upwardly facing opening, as shown in FIG. 1. Preferably, the sheet is sufficiently thin that the impact of fluid emitted from the fluid spray assembly 16 against the underside of the sheet transmits a massaging effect through the sheet to the body of the user 100. Further, the sheet is preferably of a sufficient flexibility and resiliency to substantially conform to the body of the user 100 for maximum transmission of the massage effect through the sheet to the user 100. In this manner, the sheet functions in the nature of a waterproof membrane to keep the user 100 dry during body massage operations of the apparatus 10 without noticeably dampening the massaging impact of fluid emitted from the fluid spray assembly 16. For example, a latex rubber in sheet form, in the range of 15 to 55 mil. thickness, is a suitable material to provide these characteristics for the sheet, although various other commercially available rubber and plastic sheeting materials should also provide suitable results.

As a primary means of weight bearing support of the user 100, an open-mesh netting (not shown) may be affixed in tensioned condition to the flange 32 of the base housing shell 13 horizontally across its opening immediately beneath the sheet. The netting should be of sufficient strength to independently support the weight of a user 100 to provide a safety barrier in the event of a rupture or other failure of the sheet. At the same time, the open-mesh construction of the netting permits essentially unrestricted transmission of fluid from the fluid spray assembly 16 through the netting and against the underside of the sheet.

Referring now to FIG. 2, the fluid spray assembly 16 includes an elongate massage spray head, generally indicated at 44, oriented transversely across substantially the widthwise extent of the user's body. The massage head 44 may be of any of various possible configurations and componentry adapted to emit the massage fluid under pressure against the underside of the sheet. For example, in one possible configuration, the massage head 44 may have a substantially hollow outer body 52 with a plurality of emission openings 56, each in the form of a nozzle, over substantially the full extent of the upward surface of the body 52 which faces the sheet. The emission openings 56 deliver pressurized fluid from the body 52 in a jet-like spray upwardly therefrom against the underside of the sheet.

The hollow outer body 52 of the massage spray head 44 is preferably formed of injection-molded upper and lower body portions. Preferably, a radiused inlet (not shown) is configured to provide a smooth inlet flow of water into the interior of the outer body 52 so that the flow within the outer body 52 is less turbulent. As well, the emission openings 56 are preferably disposed along a line that is offset from the longitudinal center axis of the hollow outer body 52. The combination of the radiused inlet 84, subsequent laminar flow within outer body 52, and the offset emission openings 56 allow the massage spray head 44 of the present apparatus 10 to attain an optimal massage spray that includes both laminar and turbulent flows, resulting in the desired massaging effect.

Still referring to FIG. 4, the elongated massage head 44 is supported at each opposite end by brackets 46 with rollers or wheels 48 for rolling travel along a track 26 traversingly back-and-forth through substantially the full lengthwise extent of the base housing shell 13 along angularly changing paths of travel following the angular configuration of the track 26. The angular track 26 is affixed interiorly to the bottom wall 30 of the base housing shell 13, preferably through substantially the full lengthwise extent of the base housing shell 13. The rollers 48 travel along the track 26 during lengthwise traversing travel along the track. Preferably, the track 26 is of one-piece construction. The traversing travel of the massage head 44 is driven reciprocally back-and-forth through the lengthwise extent of the base housing shell 13 via any suitable drive mechanism. For example, a toothed timing belt (not shown) may be attached at opposite belt ends to each respective bracket 46 at the ends of the massage head 44, forming two endless drive belt loops which are trained about a series of toothed guide pulleys (not shown) rotatably mounted to the interior surfaces of the side walls 21 (FIG. 4) adjacent the track 26 at each opposite end of the base housing shell 13 and also at the location of each change of angular direction in the track 26. The pulleys at one end of the base housing shell 13 would then be secured to a common drive shaft journaled through one side wall 21 and connected exteriorly thereof to a reversible drive motor (not shown) for imparting synchronous drive motion to the belts and, in turn, to the massage head 44 to travel along the track 26.

The pressurized fluid is delivered from the fluid supply arrangement 18 to the massage head 44 in any suitable way. For example, the pressurized fluid supply arrangement 18 may have an electric motor 90 driving the liquid pump 26 to draw fluid from the liquid storage reservoir 29, both the liquid pump 26 and the water storage reservoir 29 being stored within the enclosure 25 of the base housing shell 13. The outlet side of the pump 26 delivers the fluid under pressure to the massage head 44 through a suitable conduit (not shown) that is in fluid communication with the outer body 52 of the massage head 44.

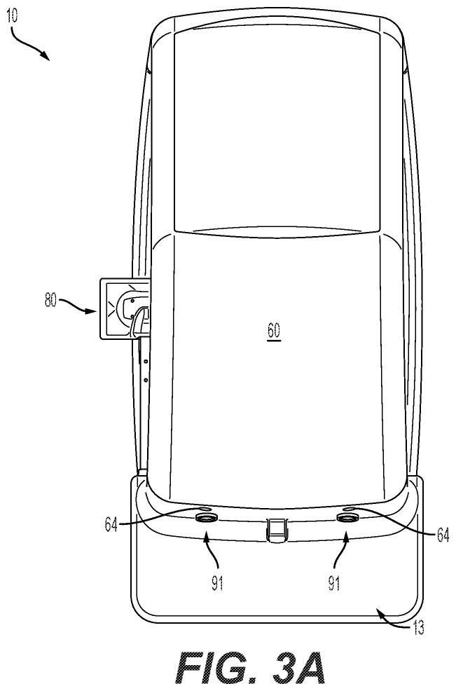

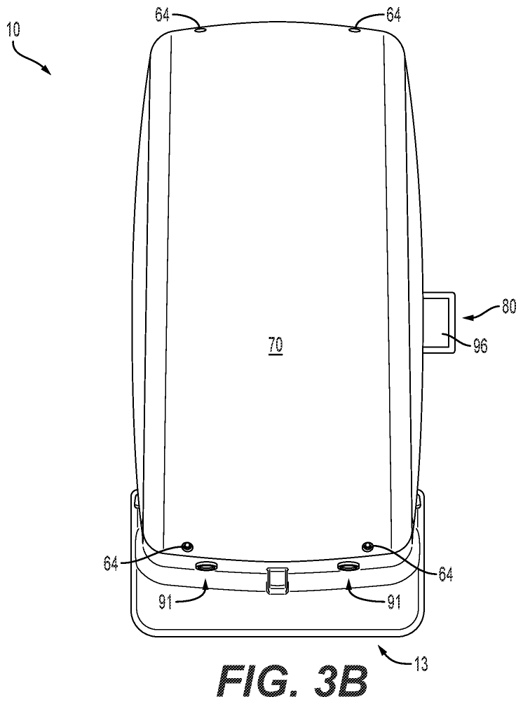

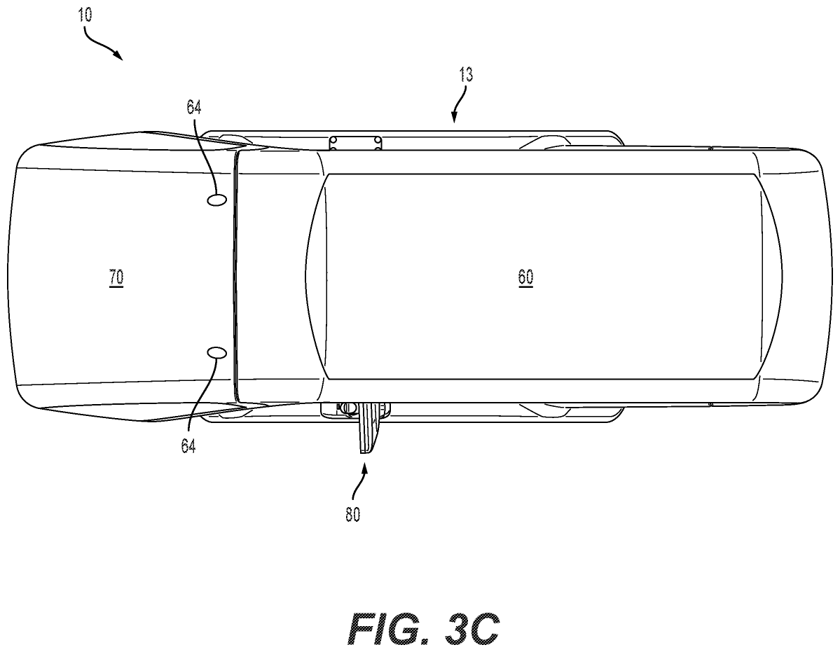

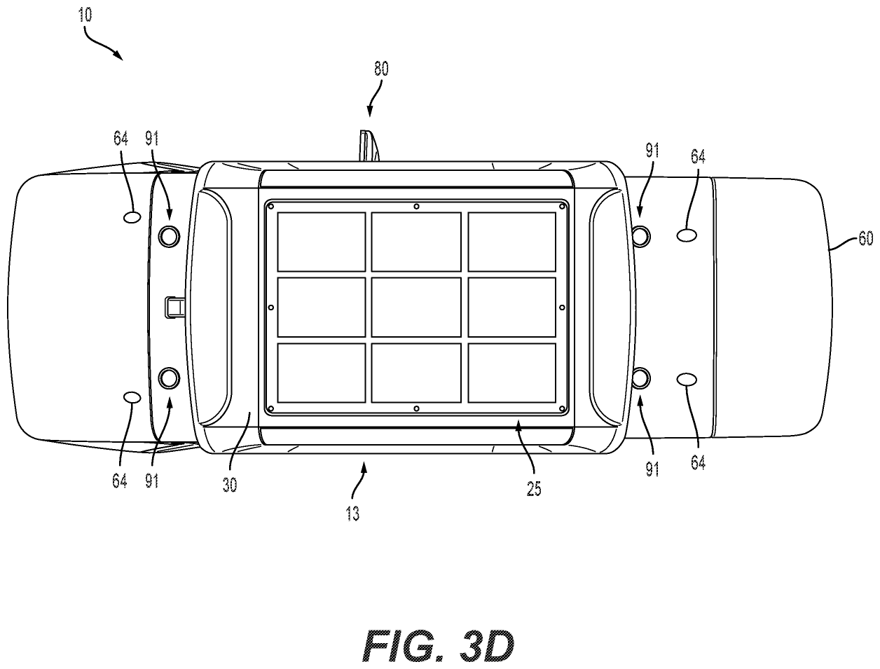

Referring now to FIGS. 1A and 4, the apparatus 10 includes a top cover structure 15 that is preferably constructed of a hollow front cover shell 60 and a hollow rear cover shell 70. Similarly to the base housing shell 13, front cover shell 60 and rear cover shell 70 are preferably formed by a rotomolding operation, with the front cover shell 60 including a pair of opposed flanges 62a/62b and the rear cover shell 70 including a pair of opposed flanges 72a/72b. As best seen in FIG. 4, a first flange 72a of rear cover shell 70 is correspondingly shaped to a first flange 17a of the base housing shell 13. Similarly, a first flange 62a of the front cover shell 60 is correspondingly shaped to a second flange 17b of the base housing shell 13. Once the correspondingly-shaped flanges are matingly positioned adjacent each other, a plurality of fasteners 64 are utilized to secure the front cover shell 60 and the rear cover shell 70 to the base housing shell 13, as best seen in FIG. 3D. Additionally, front cover shell 60 includes a second flange 62b that is correspondingly-shaped to the second flange 72b of the rear cover shell 70. As shown in FIG. 3C, fasteners 64 are also used to secure the adjacent flanges of the front cover shell 60 and the rear cover shell 70 together. By forming the housing structure 12 of hollow rotomolded portions, assembly of the apparatus 10 is simplified as all wiring, liquid piping, electrical components, etc., may be readily routed and disposed within the hollow housing structure 12. Note also, the front cover shell 60 includes a recess 66 for receiving a video display panel 86, whereas the rear cover shell 70 includes a pair of recesses 74 for receiving either fans, or vents, of a climate control system, as discussed in greater detail below. Note, in alternate embodiments, the housing structure 12 may be formed of more than, or less than, three shell portions. Moreover, the housing structure need not be formed by rotomolding in alternate embodiments.

Still referring to FIGS. 1A and 4, the preferred embodiment of the housing structure 12 of the assembly 10 also includes a pair of side panels 71 extending forwardly from the rear cover portion 70 in the vicinity of the head of the user 100. The side panels 71, along with the top cover portion 15, offer the user a feeling of privacy not afforded by standard massage beds. However, because the remainder of each side of the assembly remains open, a user 100 should be able to get the feeling of privacy while avoiding any feelings of claustrophobia. However, in alternate embodiments, one side of the assembly may be fully enclosed while the opposite side remains open. Further, in alternate embodiments, a curtain or shade may be provided on the open side, or sides, for full privacy when desired. Although the embodiment shown is designed to support only one user, alternate embodiments may be wide enough so that multiple users may utilize the assembly simultaneously.

Referring again to FIG. 4, an alternate embodiment of an apparatus is discussed. Although the housing structure 12 is practically identical to that of the previously discussed embodiment (FIGS. 1A, 1B, and 1C), the present embodiment does not include a fluid spray assembly 16. Rather, the present embodiment includes one or more of heating elements 85, vibratory motors, or liquid bags 97 disposed within the user support surface 14. The user support surface 14 is substantially thicker than that of the first embodiment so that the components noted above may be stored therein in close contact to the user. Where liquid bags 97 are present, a fluid supply arrangement 18 is required to circulate liquid of the desired temperature through the liquid bags 97. However, in these embodiments where only heating elements 85 and vibratory motors 87 are utilized, the fluid supply may be omitted, as well as the enclosure 25.

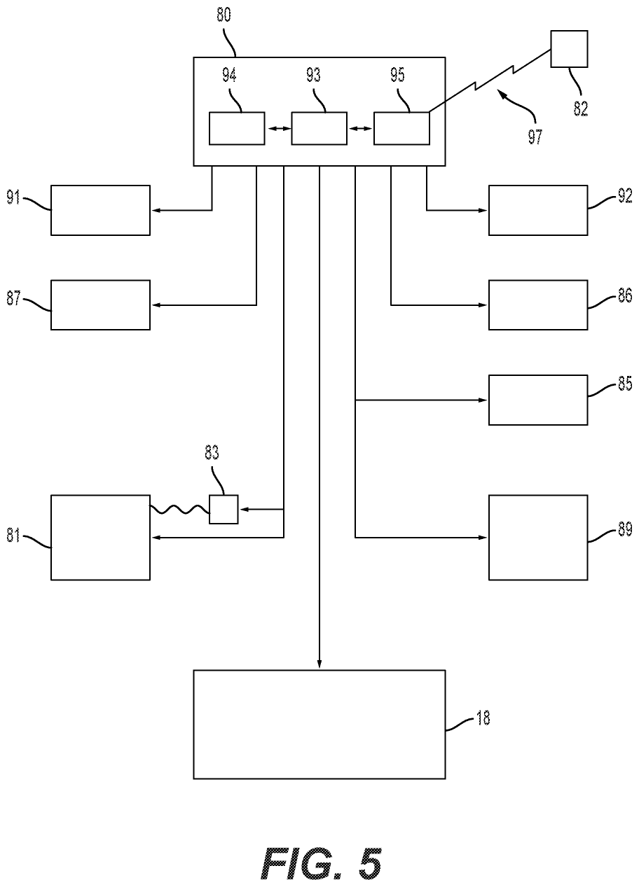

Referring additionally now to FIG. 5, the recovery and wellness apparatus 10 is configured to perform a number of therapeutic operations on a user 100. For example, not only does the apparatus 10 include an ergonomic user support surface 14 to properly position the user during operations such as, but not limited to, hydrotherapy, vibratory massage, and heat treatments, as discussed in greater detail below, but the apparatus 10 also includes a large video display panel 86 received in recess 66 of the front cover shell 60, audio speakers 87 mounted to the inner wall of the front cover shell 60 (as shown in FIG. 2) adjacent the user's head, fans or vents 81 received in recesses 74 of the rear cover portion 70, a scent chamber 83 associated with the fans/vents of the climate control system, heating and/or vibrating motors 85 and 89 (FIG. 4), respectively, disposed within the user support surface 14, and as previously discussed, the fluid supply arrangement 18 for performing water massage treatments. All of these operations may be controlled by a user interface display 80 that is positioned for easy access by a user 100 while disposed on the user support surface 34, as best seen in FIG. 1A. For example, by way of a touchscreen 96 on the user interface display 80, the user 100 may select content for display on the video display panel 86 that may include, but is not limited to, nature relaxation videos, guided meditation videos, travel videos, healthy living videos, reading exercise videos, motivational/inspirational videos, and mindfulness videos. The audio to accompany these videos or wellness content is preferably provided by the speakers 87. Note, however, if the video display panel 86 is not being utilized, the speakers 87 may be utilized to listen to alternate content such as music, casts, etc. The speakers 87 are positioned adjacent the user's head so that the user 100 can enjoy full audio, yet not disturb others in the surrounding environment. Note also, the video display panel 86 may be utilized for viewing movies, standard programming, playing video games, etc.

In a preferred embodiment of the apparatus 10, the vents 81 of a climate control system are disposed within the apparatus 10 so that a user 100 may select to create air flow that is either warmer or cooler than the surrounding environment. Alternately, fans may be used in place of a climate control system so that ambient air is merely recirculated. Working in concert with the climate control system, a scent chamber 83 is provided that when activated by the user 100, releases a desired scent that will pass through the vents 81 (or fans) of the climate control system. For example, a scent option may be selected that accompanies a video experience that a user 100 is viewing on the video display panel, such as a pine scent when viewing a program related to forests. Users may also activate heating elements 85 and/or vibratory motors 89 (FIG. 4) that are disposed within the user support surface 14 to provide a vibration massage and/or heat treatment. Alternately, as discussed in greater detail above with regard to preferred embodiments that include hydrotherapy operations, the user 100 may control the fluid supply arrangement 18 to select the appropriate level of massage and desired temperature of the liquid being utilized.

Additionally, as best seen in FIG. 3D, the user interface display 80 may be used to control LED lighting 91 that is disposed on the underside of the housing structure 12 for the purpose of adding a slight illumination to the room in which the apparatus 10 is located. As well, any of a plurality of sensors 92 including, but not limited to, respiratory sensors, pulse oximeters, heart rate monitors, eye motion sensors, etc., may be controlled and monitored through the user interface display 80.

As shown in FIG. 5, the user interface display may include a processor 93, a memory 94, and a communications interface 95. The processor 93 may be any means configured to execute various programmed operations or instructions stored in a memory device such as a device or circuitry operating in accordance with software or otherwise embodied in hardware or a combination of hardware and software thereby configuring the device or circuitry to perform the corresponding functions of the processor 93 as described herein. In this regard, the processor 93 may be configured to analyze electrical signals communicated thereto in the form of user input commands via the touchscreen. The memory 310 may be configured to store instructions, computer program code, programming, health information, etc., in a non-transitory computer-readable medium for use, such as by the processor 305. The communication interface 95 may be configured to enable connection to external systems. In this manner, the processor 93 may retrieve stored data from external servers via the communication interface 95, in addition to or as an alternative to the memory 94. For example, a user may input commands through a wireless connection 111 with the communications interference 95 with a personal electronic device 82 such as, but not limited to, a cell phone, tablet, laptop computer, etc.

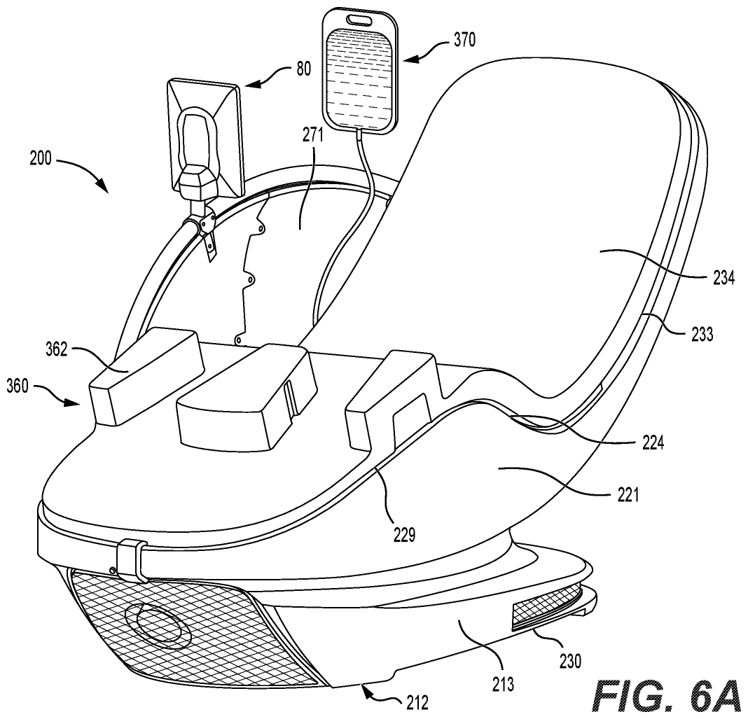

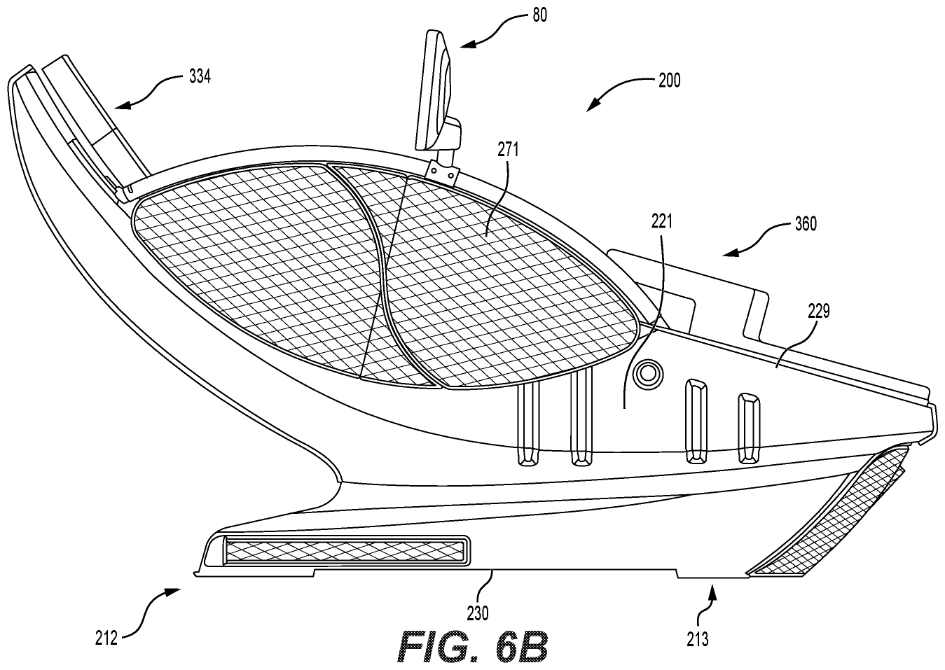

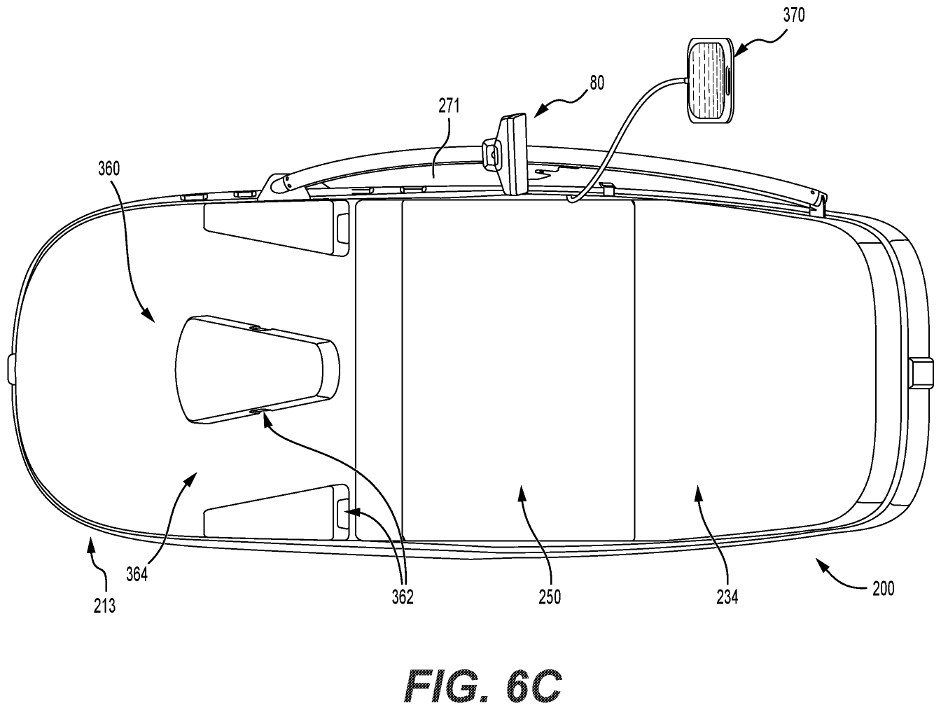

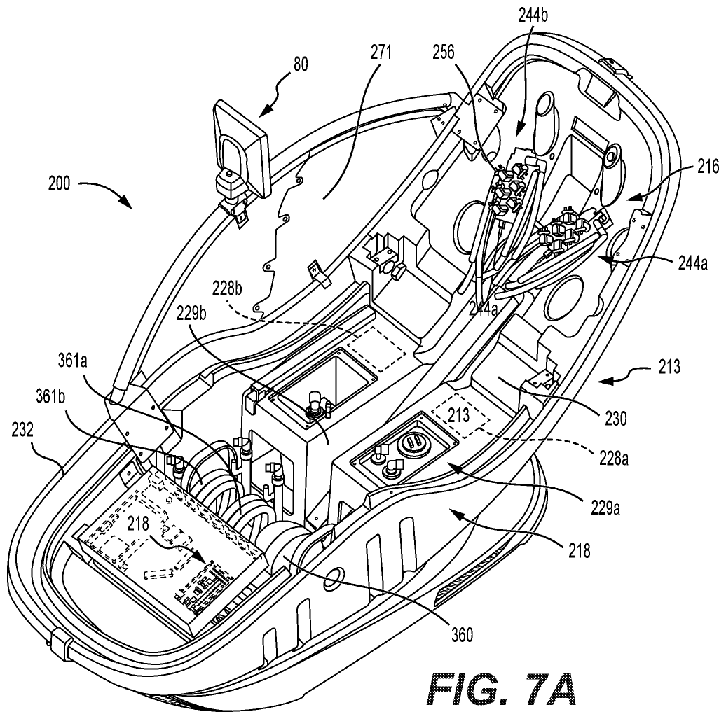

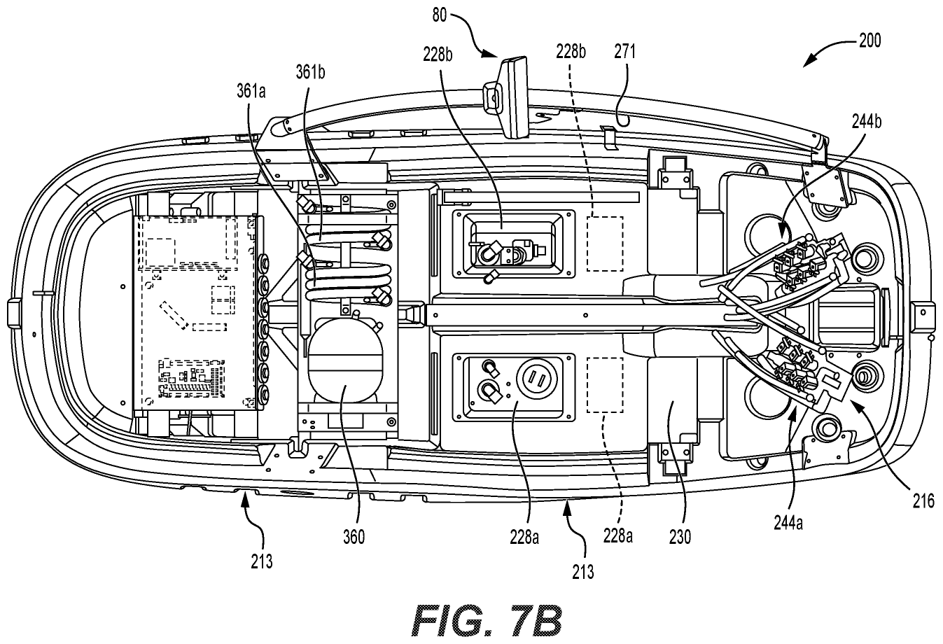

Referring now to FIGS. 6A through 6C, a recovery and wellness apparatus according to an alternate embodiment of the present disclosure is generally indicated at 200. The apparatus 200 includes a housing structure, generally indicated at 212, generally in the form of a hollow lounge chair-style base housing shell 213. The base housing shell 213 presents an upwardly facing top side configured to receive a user support surface 234 thereon that is designed for a user 100 (FIG. 1A) to rest thereon for treatment. These treatments may include, but not limited to, heat/cold application massage, aromatherapy, auditory sessions, etc., in a seated reclining position, as more fully explained hereinafter. A fluid spray assembly, generally indicated at 216 (FIGS. 7A and 7B), is disposed within the base housing shell 213 in association with a pressurized fluid supply arrangement 218, which is disposed within the hollow base housing shell as well and includes a pair of pumps 228a and 228b (FIG. 7A), preferably a liquid pump, for directing a pressurized fluid emission from a pair of liquid storage reservoirs 229a and 229b at the underside of the user support surface 234 to transmit a massaging effect therethrough to the body of the user 100 seated thereon.

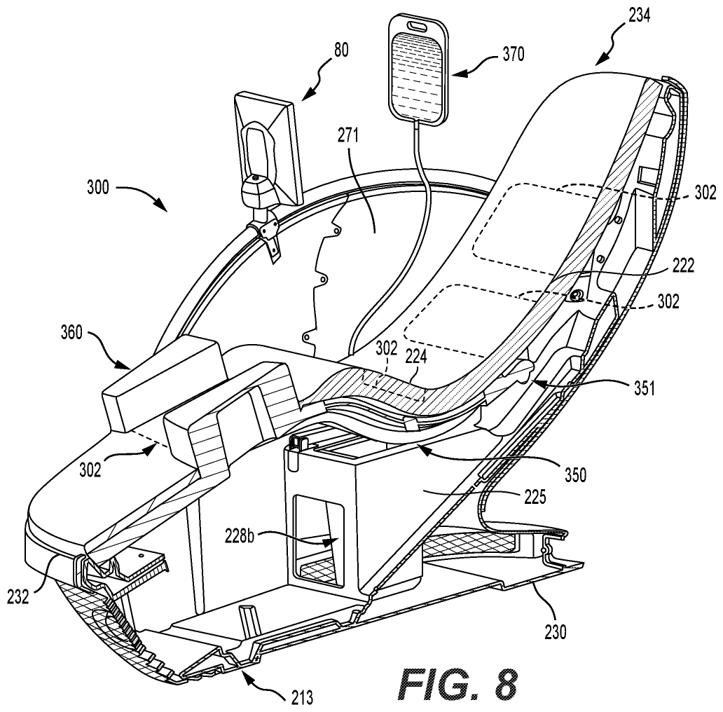

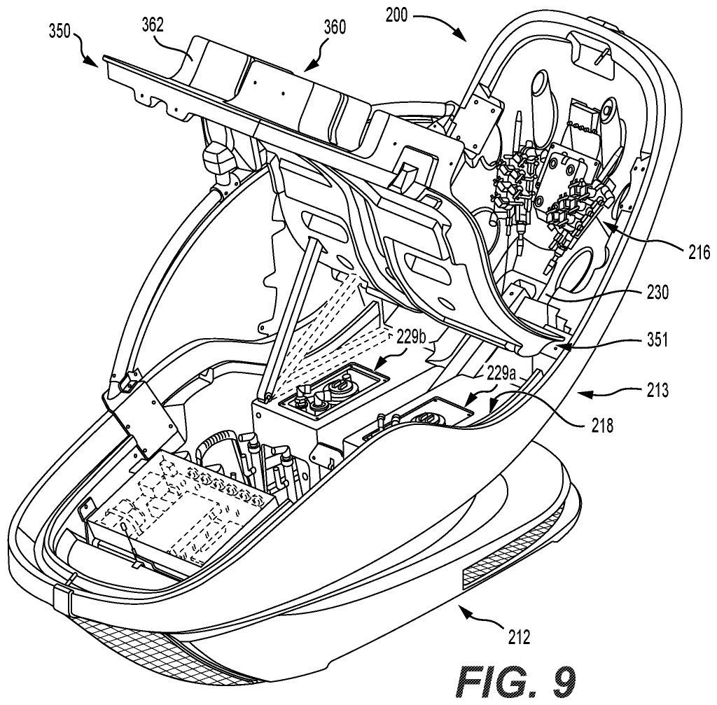

Referring additionally to FIG. 8, the base housing shell 213 is preferably generally in the form of a tank or tub of an elongated configuration having a bottom wall 230 and side walls 221, and substantially open at its top to define an upwardly-facing elongated opening. Preferably, the bottom wall 230 may also define an aperture therein that is configured to receive an enclosure 225 therein for containing various components of the fluid supply arrangement 218, such as the pumps 228a and 228b, fluid reservoirs 229a and 229b, etc. As shown in FIG. 8, the perimeter of the aperture defined in the bottom wall 230 of the base housing shell 213 forms a leak-proof seal with the outer surface of the enclosure 225. As such, water utilized by the fluid spray assembly 216 during massage treatment of the user 100 is retained within the base housing shell 213 until returned to the water storage reservoirs within the enclosure 225 via associated piping. The base housing shell 213 may be fabricated of any suitable watertight, rigid material of appropriate strength which may be formed to the desired configuration herein described, e.g., fiberglass, plastic, or a like material. The base housing shell 213 provides an open volume beneath the user support surface 234 for enclosure of various operating components of the apparatus 200. As shown in FIG. 9, the open volume of the base housing shell 213 is readily accessible via a hinged lid 350 that is pivotably attached to the base housing shell 213 at hinge 351 and defines a lower portion of the user support surface. The hinged lid 350 allows easy access to the internal components of the recovery and wellness apparatus for both scheduled cleaning and maintenance operations.

As best seen in FIG. 6A, the lateral side walls 221 of the base housing shell 213 are contoured to form a substantially-planar seat back portion 222 and a seat portion 224 having a substantially-planar leg portion 229, supporting the user support surface 234. Preferably, the seat back portion 222 and the leg portion 229 are angularly oriented with respect to each other, with the seat portion 224 being disposed therebetween. The user support surface 234 is configured so that the upper and lower body portions 101 and 103 (FIG. 1A), respectively, of the user 100 are supported in a generally reclining seated disposition comparable to that of a lounge-style chair wherein the user's body rests bent at the waist and knees with the upper body portion 101 partially reclined on the seat back portion 222, the upper leg extent of the lower body portion 103 slightly inclined on the seat portion 224, and the lower leg extent of the lower body portion 103 slightly declined on the leg portion. The slight bend of the knees of the user's legs help to maintain the user 100 in the proper position on the user support surface 234. As such, the pressurized water jets will impact the user 100 in the proper areas of the user's body to achieve the desired massaging effect.

As shown in FIGS. 6A through 6C, the user support surface 234 includes a lower leg massage assembly 360 disposed on the portion of the surface on which a user's lower legs, or calves, rest. As shown, these upward projections 362 form two independent channels 364, one for each user's calf. Each channel 364 includes a fluid bag 302 that, similarly to the other fluid bags 302, may be filled with either hot fluids or cold fluids from the corresponding fluid reservoirs. As such, the apparatus may perform both hot and cold treatments on the user's calves, as well as massaging pressure treatments, as controlled by the user. Additionally, one or more axially fluid bags 370 are in fluid communication with the apparatus and enable a user to place the auxiliary fluid bag 370 on a desired portion of the body, such as a shoulder, elbow, hand, etc.

A liquid medium is preferred as the fluid medium utilized by the apparatus 200 for supply to and emission from the fluid spray assembly 216 to produce a massage effect as hereinafter described, water being an optimal liquid in view of its ready availability and generally non-corrosive and non-caustic character. As noted, a suitable supply of water is stored in the water storage reservoirs 229a and 229b for continuous circulation through the fluid supply arrangement 218 to the fluid spray assembly 216. The bottom drainage wall 230 (FIG. 7A), as well as the other interior surfaces of the base housing shell 213 are configured to drain the liquid emitted from the fluid spray assembly 216 into the water storage reservoirs 229a and 229b. Of course, as those persons skilled in the art will readily recognize, pressurized air, other gases, and other fluidic materials could also be utilized as the fluid massaging medium without departing from the scope and substance of the present disclosure and, accordingly, the present disclosure is not intended to be and should not be construed as limited to the use of water or another liquid massage medium. Note, in alternate embodiments, only one water storage reservoir is utilized, with the water being directed to either heating or cooling mechanisms by way of solenoid operated valves.

It is also preferred that the water or other massage liquid be either heated or cooled to enhance the massaging effect produced by the liquid. For example, where the application of heat to an individual is desired, the liquid may be heated to a temperature that is preferably in the range of 95 to 115 degrees Fahrenheit, although the apparatus has the capability of a broad range of liquid temperatures. For this purpose, a compressor 360 and coil 361a may be provided to heat the fluid to the desired temperature. Alternately, a heater element (not shown) may be provided, e.g., mounted within the storage reservoir that is used for warm fluids. The heating element is disposed below the normal level of massage liquid therein to be substantially continuously submerged in the stored massage liquid. A thermostat (not shown) is preferably provided in the electrical circuit to the heating element to provide selective control of the temperature of the massage liquid by the user. As well, the heating apparatus may be external to the corresponding storage reservoir with water being directed thereto as desired by the user. Similarly, a refrigeration unit comprised of the compressor 360 and a second coil 361b may be used to cool the water that is stored in the corresponding reservoir that the corresponding fluid pump accesses when applying cooler fluids to the individual during treatments. For example, the present embodiment is able to provide cool fluids in the range of 28 to 40 degrees, although alternate ranges are possible. In yet another embodiment, only one storage reservoir is utilized, with fluids being directed to the corresponding compressor 360a,b and coil 361a,b, by solenoid operated valves.

In the embodiment of the apparatus 200, in which the fluid spray assembly 216 is utilized for fluid massage, as shown in FIGS. 7A and 7B, the user support surface 234 may be formed of a relatively thin sheet of a waterproof material affixed in watertight relationship with a flange 232 bordering the upwardly facing opening, as shown in FIG. 8. Preferably, the sheet is sufficiently thin that the impact of fluid emitted from the fluid spray assembly 216 against the underside of the sheet transmits a massaging effect through the sheet to the body of the user 100. Further, the sheet is preferably of a sufficient flexibility and resiliency to substantially conform to the body of the user 100 for maximum transmission of the massage effect through the sheet to the user 100. In this manner, the sheet functions in the nature of a waterproof membrane to keep the user 100 dry during body massage operations of the apparatus 200 without noticeably dampening the massaging impact of fluid emitted from the fluid spray assembly 216. For example, a latex rubber in sheet form, in the range of 15 to 55 mil. thickness, is a suitable material to provide these characteristics for the sheet, although various other commercially available rubber and plastic sheeting materials should also provide suitable results.

As a primary means of weight bearing support of the user 100 when fluid spray is used as the primary means of massage, an open-mesh netting (not shown) may be affixed in tensioned condition to the flange 232 of the base housing shell 213 horizontally across its opening immediately beneath the sheet. The netting should be of sufficient strength to independently support the weight of a user 100 to provide a safety barrier in the event of a rupture or other failure of the sheet. At the same time, the open-mesh construction of the netting permits essentially unrestricted transmission of fluid from the fluid spray assembly 16 through the netting and against the underside of the sheet.

Referring now to FIGS. 7A and 7B, the fluid spray assembly 216 includes a pair of massage spray heads, generally indicated at 244a and 244b, oriented on opposite sides of the longitudinal center axis of the apparatus 200. The massage heads 244a and 244b may be of any of various possible configurations and componentry adapted to emit the massage fluid under pressure against the underside of the sheet. For example, in one possible configuration, the massage heads 244a and 244b may have a plurality of emission openings 256, each in the form of a nozzle, forming slightly different angles with the underside of the support surface 234 and, therefore, user 100. The emission openings 256 deliver pressurized fluid in a jet-like spray upwardly therefrom against the underside of the sheet.

The pressurized fluid is delivered from the fluid supply arrangement 218 to the massage heads 244a and 244b in any suitable way. For example, the pressurized fluid supply arrangement 218 may have an electric motor driving the liquid pumps 228a and 228b to draw fluid from the corresponding liquid storage reservoirs 229a and 229b, both the liquid pumps 228a and 228b and the water storage reservoirs being stored within the enclosure of the base housing shell 213. The outlet side of the pumps 228a and 228b deliver the fluid under pressure to the massage heads 244a and 244b through a suitable conduit (not shown).

The assembly 200 shown also includes a privacy panel 271 extending from the head of the user 100 to the left of the user 100. The privacy panel 271 offers the user a feeling of privacy not afforded by standard massage beds. However, because the remainder of the assembly 200 remains open, a user 100 should be able to get the feeling of privacy while avoiding any feelings of claustrophobia. Note, in alternate embodiments, privacy panels 271 may be included on both sides of the apparatus 200. Although the embodiment shown is designed to support only one user, alternate embodiments may be wide enough so that multiple users may utilize the assembly simultaneously.

Referring again to FIG. 8, an alternate embodiment of a wellness and apparatus is discussed. Although the housing structure is practically identical to that of the previously discussed embodiment (FIGS. 6A through 7B), the present embodiment of the apparatus 300 does not include a fluid spray assembly. Rather, the present apparatus includes one or more of heating elements, vibratory motors, or fluid bags 302 disposed within the user support surface 234. The user support surface 234 is substantially thicker than that of the embodiment of FIGS. 1A through 1C so that the components noted above may be stored therein in close contact to the user. Where fluid bags 302 are present, a fluid supply arrangement 318 is required to circulate liquid of the desired temperature through the fluid bags 302. Where only heating elements 385 and vibratory motors 387 are utilized, the fluid supply may be omitted.

As shown in FIG. 8, the wellness apparatus 300 includes multiple fluid bags 302 that may be filled with either hot fluid or cold fluid from the corresponding fluid pumps 228a and 228b and reservoirs 229a and 229b. Having multiple fluid bags 302 allows various portions of the user's body to be subjected to either hot fluid and/or cold fluids simultaneously. For example, while applying cool therapy to a user's claves, a warm treatment may be applied to the user's back, upper legs or thighs, etc. As such, unlike traditional methods that require full body immersion in an ice bath or cryotherapy device may cause great discomfort, the present apparatus 300 can provide warming effects to the areas of the user's body that are not undergoing cooling treatment, thereby making the experience much more pleasurable. As well, one or more auxiliary fluid bags 370 may be included to apply hot/cold compression to portions of the user's body that are not in contact with the other fluid bags 302.

It will therefore be readily understood by those persons skilled in the art that the present disclosure is susceptible of a broad utility and application. Many embodiments and adaptations of the present disclosure other than those herein described, as well as many variations, modifications and equivalent arrangements, will be apparent from or reasonably suggested by the present disclosure and the foregoing description thereof, without departing from the substance or scope of the present disclosure. Accordingly, while the present disclosure has been described herein in detail in relation to its preferred embodiment, it is to be understood that this disclosure is only illustrative and exemplary of the present disclosure and is made merely for purposes of providing a full and enabling disclosure of the invention. The foregoing disclosure is not intended or to be construed to limit the present disclosure or otherwise to exclude any such other embodiments, adaptations, variations, modifications and equivalent arrangements, the present disclosure being limited only by the claims appended hereto and the equivalents thereof.

1. An apparatus for massage of a user in a reclined position, comprising:
a housing structure having a base portion with a user support surface for supporting the user in a reclined position, and
a massage assembly disposed adjacent the user support surface, the massage assembly including:
at least one fluid storage reservoir;
at least one fluid bag disposed within the user support surface; and
at least one fluid pump in fluid communication with both the at least one fluid storage reservoir and the at least one fluid bag,
wherein the at least one fluid pump is configured to circulate fluid from the at least one fluid storage reservoir to the at least one fluid bag.

2. The apparatus of claim 1, wherein the at least one fluid storage reservoir includes a first and a second fluid storage reservoir, the at least one fluid bag includes a first and a second fluid bag, and the at least one fluid pump includes a first and a second fluid pump, wherein the first fluid pump is in fluid communication with the first fluid reservoir and the second fluid pump is in fluid communication with the second fluid reservoir.

3. The apparatus of claim 2, wherein the first fluid reservoir contains fluid at a first temperature, the second fluid reservoir contains fluid of a second temperature, and the first temperature is greater than the second temperature.

4. The apparatus of claim 3, wherein the massage assembly further comprises a heating element disposed within the first fluid storage reservoir.

5. The apparatus of claim 4, wherein the first fluid pump and the second fluid pump are selectively placed in fluid communication within the first fluid bag and the second fluid bag.

6. The apparatus of claim 1, wherein the user support surface further comprises a substantially planar seat back portion, a substantially planar leg portion, and a seat portion disposed therebetween, wherein the seat back portion and the leg portion form an angle therebetween.

7. The apparatus of claim 6, wherein the massage assembly further comprises a fluid spray assembly disposed within the base portion of the housing structure for directing a fluid stream at the user support surface for imparting a massaging effect through the user support surface to an upper body portion and a lower body portion of the user.

8. The apparatus of claim 7, wherein the user support surface comprises a waterproof membrane and an open net mesh disposed both adjacent to and below the waterproof membrane.

9. The apparatus of claim 1, wherein the massage assembly further comprises a plurality of vibratory motor disposed within the user support surface.

10. The apparatus of claim 9, wherein the massage assembly further comprises a plurality of heating elements disposed within the user support surface.

11. An apparatus for massage of a user, comprising:
a housing structure having a base portion with a user support surface for supporting the user in a reclined position, and
a massage assembly disposed adjacent the user support surface, the massage assembly including:
at least one fluid storage reservoir;
at least one fluid bag disposed within the user support surface;
a fluid cooling assembly;
a fluid heating assembly; and
at least one fluid pump in fluid communication with the at least one fluid storage reservoir and the at least one fluid bag,
wherein the at least one fluid pump is configured to circulate fluid from the at least one fluid storage reservoir, the fluid cooling assembly, the fluid heating assembly, and the at least one fluid bag.

12. The apparatus of claim 11, wherein the at least one fluid storage reservoir includes a first and a second fluid storage reservoir, the at least one fluid bag includes a first and a second fluid bag, and the at least one fluid pump includes a first and a second fluid pump, wherein the first fluid pump is in fluid communication with the first fluid reservoir and the second fluid pump is in fluid communication with the second fluid reservoir.

13. The apparatus of claim 12, wherein the first fluid reservoir contains fluid at a first temperature, the second fluid reservoir contains fluid of a second temperature, and the first temperature is greater than the second temperature.

14. The apparatus of claim 13, wherein the first fluid pump and the second fluid pump are selectively placed in fluid communication within the first fluid bag and the second fluid bag.

15. The apparatus of claim 11, wherein the user support surface further comprises a substantially planar seat back portion, a substantially planar leg portion, and a seat portion disposed therebetween, wherein the seat back portion and the leg portion form an angle therebetween.

16. The apparatus of claim 15, wherein the massage assembly further comprises a fluid spray assembly disposed within the base portion of the housing structure for directing a fluid stream at the user support surface for imparting a massaging effect through the user support surface to an upper body portion and a lower body portion of the user.

17. The apparatus of claim 16, wherein one of the fluid cooling assembly and the fluid heating assembly are selectively placeable in fluid communication with the fluid spray assembly.

18. The apparatus of claim 11, wherein the massage assembly further comprises a plurality of vibratory motors and a plurality of heating elements disposed within the user support surface.
